(19) United States
(12) Patent Application Publication
(10) Pub. No.: US 2012/0007508 A1
(43) Pub. Date: Jan. 12, 2012

(54) LED LAMP BRIGHTNESS ADJUSTING CIRCUIT CONNECTABLE TO AC POWER AND LED LIGHTING DEVICE USING THE SAME

(76) Inventor: Chiu-Min Lin, Guishan Township (TW)

(21) Appl. No.: 12/833,019

(22) Filed: Jul. 9, 2010

(51) Int. Cl. H05B 37/02

(52) U.S. Cl. 315/127; 315/294

(57) ABSTRACT

A LED lamp brightness adjusting circuit has a regulating circuit, multiple rectification diodes and filtering capacitors. Each filtering capacitor is connectable to a LED module in parallel. The LED lamp brightness adjusting circuit is connected to an output terminal of a light regulator. Based on the control of light regulator, the regulating circuit produces a regulated AC input voltage. The positive and negative half cycles of the regulated AC input voltage are further rectified and filtered to drive different corresponding LED modules. Therefore, the amplitude of the drive voltages for the LED modules are controllable to adjust the brightness of the emitted light.

### BACKGROUND OF THE INVENTION

1. Field of the Invention

The present invention relates to a LED lamp brightness adjusting circuit connectable to AC power and a LED lighting device using the brightness adjusting circuit, especially to a brightness adjusting circuit that allows a light regulator to alter the brightness of the LED lamp.

2. Description of the Related Art

Light adjustable lamps are often used to provide comfortable ambiance. With reference to FIG. 2, a conventional light adjustable lamp mainly includes an incandescent lamp (101) and a light regulator (102) connected in series. The light regulator (102) is composed of silicon-controlled elements such as DIAC (diode for alternating current) and TRIAC (triode for alternating current). By changing a trigging voltage applied to the silicon-controlled element, the conduction angle of the silicon-controlled element is adjusted to control the AC voltage across the incandescent lamp (101) and accordingly regulate the brightness of the incandescent lamp (101) to a desired level.

More and more LED-based lamps are used as lighting equipment and are replacing conventional incandescent lamps for saving energy and reducing power consumption. The LED-based lamps are driven by low DC voltages. However, the light regulator (102) is unable to directly regulate the DC voltage and cannot adjust the brightness of the LED-based lamps. Therefore, users have to use particular regulators to substitute the existed light regulators and almost abandon all original related control circuits.

To overcome the shortcomings, the present invention provides a LED lamp brightness adjusting circuit connectable to AC power to mitigate or obviate the aforementioned problems.

### SUMMARY OF THE INVENTION

The main objective of the invention is to provide a LED lamp brightness adjusting circuit, wherein the brightness adjusting circuit allows a light regulator to change the brightness of the LED lamp.

To achieve the objective, the LED lamp brightness adjusting circuit includes a regulating circuit, multiple rectification diodes and filtering capacitors. Each filtering capacitor is connectable to a LED module in parallel. The LED lamp brightness adjusting circuit is connected to an output terminal of a light regulator that receives an AC voltage. As the light regulator adjusts the amplitude of the AC voltage, the regulating circuit produces a regulated AC input voltage. The positive and negative half cycles of the regulated AC input voltage are further rectified and filtered to drive different corresponding LED modules. Because the amplitude of the drive voltages for the LED modules are adjustable, the brightness of the emitted light can be changed depend on a user's requirement.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a LED lamp brightness adjusting circuit connectable to AC power in accordance with the present invention; and

FIG. 2 is a block circuit diagram of a conventional light adjustable lamp.

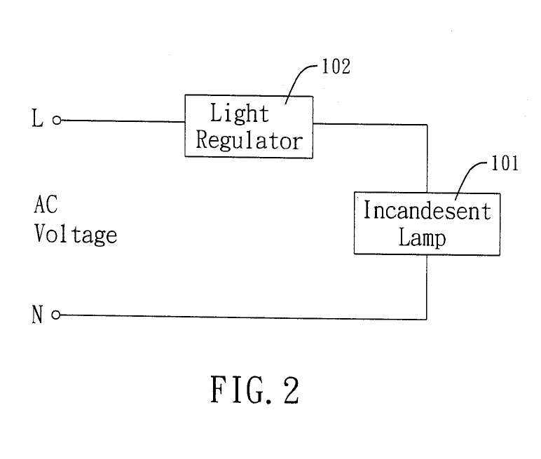

### DETAILED DESCRIPTION OF THE PREFERRED EMBODIMENTS

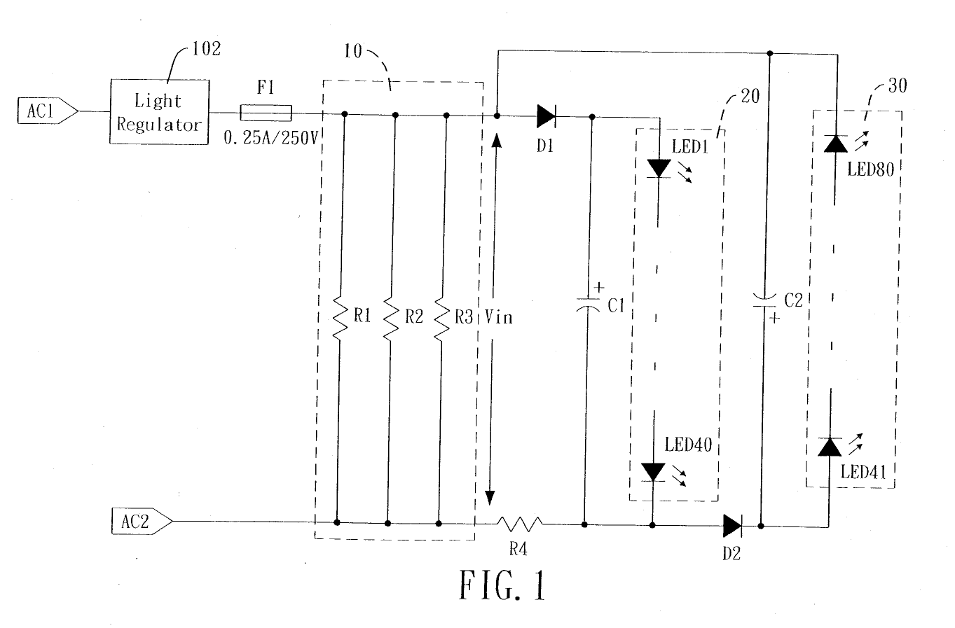

With reference to FIG. 1, a LED lamp brightness adjusting circuit in accordance with the present invention is operated with a light regulator 102 and comprises a regulating circuit 10, a first rectification diode D1, a second rectification diode D2, a first filtering capacitor C1, a second filtering capacitor C2 and a current limiting resistor R4. The light regulator 102 has an input terminal connected to a first AC input terminal AC1 of an AC power source.

The regulating circuit 10 has a first terminal and a second terminal and comprises multiple resistors R1 to R3 connected in parallel. The first terminal is coupled to an output terminal of the light regulator 102. The second terminal is coupled to a second AC input terminal AC2 of the AC power source. An optional fuse F1 may be connected between the regulator 102 and the regulating circuit 10 to provide over current protection. The resistors R1 to R3 of the regulating circuit 10 in this embodiment have the same resistance value. The regulating circuit 10 allows the light regulator 102 to linearly regulate the AC voltage and produces a regulated input voltage Vin across the first terminal and the second terminal.

The first rectification diode D1 has an anode and a cathode, wherein the anode is connected to the first terminal of the regulating circuit 10 and the cathode is connected to the first filtering capacitor C1.

The first filtering capacitor C1 has a positive terminal and a negative terminal. The positive terminal is connected to the cathode of the first rectification diode D1. The current limiting resistor R4 is connected between the second terminal of the regulating circuit 10 and the negative terminal of the first filtering capacitor C1. The first filtering capacitor C1 can be connected in parallel to a first LED module 20 that includes multiple light emitting diodes LED 1 to LED 40 connected in series. The first LED module 20 has a positive input correspondingly connected to the positive terminal of the first filtering capacitor C1, and a negative input correspondingly connected to the negative terminal of the first filtering capacitor C1.

The second rectification diode D2 has an anode and a cathode, wherein the anode is connected to the second AC input terminal AC2 through the current limiting resistor R4, and the cathode is connected to the second filtering capacitor C2.

The second filtering capacitor C2 has a positive terminal and a negative terminal. The positive terminal is connected to the cathode of the second rectification diode D2. The negative terminal is connected to the first terminal of the regulating circuit 10 and the anode of the first rectification diode D1. The second filtering capacitor C2 can be connected in parallel to a second LED module 30 that includes multiple light emitting diodes LED 41 to LED 80 connected in series. The second LED module 30 has a positive input correspondingly connected to the positive terminal of the second filtering capacitor C2, and a negative input correspondingly connected to the negative terminal of the second filtering capacitor C2.

For the AC voltage input from the two AC input terminals AC1, AC2, the light regulator 102 can regulate the amplitude of the AC voltage to adjust the regulated input voltage Vin. Therefore, the driving voltages across the first and second filtering capacitors C1, C2 are changed. Because the first and the second LED modules 20, 30 are respectively coupled to the first and the second filtering capacitors C1, C2, the driving currents flowing through the LED modules 20, 30 are altered to adjust the brightness of the emitted light. When the AC voltage is in the positive half cycle, the positive half cycle voltage passes through the first rectification diode D1 and is filtered by the first filtering capacitor C1 to produce a first filtered driving voltage for activating the first LED module 20. When the AC voltage is in the negative half cycle, the negative half cycle voltage passes through the second rectification diode D2 and is filtered by the second filtering capacitor C2 to produce a second filtered driving voltage for activating the second LED module 30. The first rectified driving voltage and the second rectified driving voltage are alternately produced.

The brightness adjusting circuit of the present invention allows the light regulator 102 to adjust the amplitude of the received AC voltage and produce a regulated input voltage Vin. The regulated input voltage Vin, either the positive or negative half cycle voltage, is further rectified and filtered by the rectification diodes D1, D2 and the filtering capacitors C1, C2 to drive the LED modules 20, 30 and alter the brightness of the LED modules 20, 30.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A LED lamp brightness adjusting circuit comprising:
a regulating circuit having a first terminal and a second terminal and comprising multiple resistors connected in parallel, the first terminal adapted to connect to an output terminal of a light regulator, the second terminal adapted to connect to an AC power source, the regulating circuit output a regulated input voltage with a desired amplitude in response to the control of the light regulator;
a first rectification diode having an anode and a cathode, the anode connected to the first terminal of the regulating circuit;
a first filtering capacitor having a positive terminal and a negative terminal, the positive terminal connected to the cathode of the first rectification diode, the negative terminal connected to the second terminal of the regulating circuit, wherein the first filtering capacitor is connectable to a first LED module in parallel;
a second rectification diode having an anode and a cathode, the anode connected to the second terminal of the regulating circuit; and
a second filtering capacitor having a positive terminal and a negative terminal, the positive terminal connected to the cathode of the second rectification diode, the negative terminal connected to the first terminal of the regulating circuit, wherein the second filtering capacitor is connectable to a second LED module in parallel.

2. The LED lamp brightness adjusting circuit as claimed in claim 1, wherein the resistors of the regulating circuit have the same resistance value.

3. The LED lamp brightness adjusting circuit as claimed in claim 1 further comprising a current limiting resistor connected between the second terminal of the regulating circuit and the anode of the second rectification diode.

4. The LED lamp brightness adjusting circuit as claimed in claim 2 further comprising a current limiting resistor connected between the second terminal of the regulating circuit and the anode of the second rectification diode.

5. The LED lamp brightness adjusting circuit as claimed in claim 3 further comprising a fuse connected between the first terminal of the regulating circuit and the light regulator.

6. The LED lamp brightness adjusting circuit as claimed in claim 4 further comprising a fuse connected between the first terminal of the regulating circuit and the light regulator.

7. The LED lamp brightness adjusting circuit as claimed in claim 1, wherein
a first rectified driving voltage across the first rectifying capacitor drives the first LED module;
a second rectified driving voltage across the second rectifying capacitor drives the second LED module; and
the first rectified driving voltage and the second rectified driving voltage are alternately produced.

8. A LED lighting device comprising:
a light regulator having an input terminal connected to a first AC input terminal of an AC power source;
a regulating circuit having a first terminal and a second terminal and comprising multiple resistors connected in parallel, the first terminal connected to an output terminal of the light regulator, the second terminal connected to a second AC input terminal of the AC power source, the regulating circuit outputting a regulated input voltage with a desired amplitude in response to the control of the light regulator;
a first rectification diode having an anode and a cathode, the anode connected to the first terminal of the regulating circuit;
a first filtering capacitor having a positive terminal and a negative terminal, the positive terminal connected to the cathode of the first rectification diode, the negative terminal connected to the second terminal of the regulating circuit;
a first LED module connected to the first filtering capacitor in parallel;
a second rectification diode having an anode and a cathode, the anode connected to the second terminal of the regulating circuit;
a second filtering capacitor having a positive terminal and a negative terminal, the positive terminal connected to the cathode of the second rectification diode, the negative terminal connected to the first terminal of the regulating circuit; and
a second LED module connected to the second filtering capacitor in parallel.

9. The LED lighting device as claimed in claim 8, wherein the resistors of the regulating circuit have the same resistance value.

10. The LED lighting device as claimed in claim 8 further comprising a current limiting resistor connected between the second terminal of the regulating circuit and the anode of the second rectification diode.

11. The LED lighting device as claimed in claim 9 further comprising a current limiting resistor connected between the second terminal of the regulating circuit and the anode of the second rectification diode.

12. The LED lighting device as claimed in claim 10 further comprising a fuse connected between the first terminal of the regulating circuit and the light regulator.

13. The LED lighting device as claimed in claim 11 further comprising a fuse connected between the first terminal of the regulating circuit and the light regulator.

14. The LED lighting device as claimed in claim 8, wherein
a first rectified driving voltage across the first rectifying capacitor drives the first LED module;
a second rectified driving voltage across the second rectifying capacitor drives the second LED module; and
the first rectified driving voltage and the second rectified driving voltage are alternately produced.
